(19) United States
(12) Patent Application Publication
(10) Pub. No.: US 2024/0323318 A1
(43) Pub. Date: Sep. 26, 2024

(54) VIDEO PRESENTATION SYSTEM

(71) Applicant: INTERNATIONAL BUSINESS MACHINES CORPORATION, Armonk, NY (US)

(72) Inventors: Zhe Yan, Beijing (CN); Li Li Guan, Beijing (CN); Rong Zhao, Beijing (CN); Li Bo Zhang, Beijing (CN); Hao Xiang Wu, Beijing (CN)

(21) Appl. No.: 18/188,845

(22) Filed: Mar. 23, 2023

(51) Int. Cl. H04N 7/15; G06V 20/40; G10L 15/18

(52) U.S. Cl. CPC H04N 7/152; G06V 20/49; G10L 15/1815

(57) ABSTRACT

A computer hardware system includes a video analyzer configured to assist in a presentation of at least a portion of a video to a plurality of participants by a presenter on a presenter client and a hardware processor configured to perform the following executable operations. The video is analyzed to generate a plurality of segments. Presenter data is captured during the presentation, and presenter intent is determined based upon the presenter data. Based upon the presenter intent, forward-looking controls are presented only to the presenter client. One of the plurality of segments is identified using at least one of the presenter intent and the forward-looking controls. The identified one segment is presented to the plurality of participants.

### BACKGROUND

The present invention relates to presentation software, and more specifically, to assisting in a presentation of at least a portion of a video to a plurality of participants.

Oftentimes, during a demonstration of a product and/or service, a pre-recorded video is employed. This video can be used to demonstrate the individual features of the product and/or service. A demonstration video, however, has certain drawbacks when being presented to a live audience. As an example, the timing of the video may not match up with the timing of an explanation of video by the presenter. For example, a segment of the video explaining a particular feature may be too short compared to an explanation of that particular feature, and in this instance, the presenter may have to hurry the explanation or cut the explanation short before the next segment plays.

As another example, the presenter may want to pause the further highlight a particular feature but that pre-recorded video keeps playing. In another instance, the presenter may want to further explain a feature, but a demonstration of that feature may not occur until later on in the presentation. As such, the presenter may be forced to delay the further explanation until later on in the presentation. In yet another instance, the presenter may want to further explain a feature in response to a question from the audience but the video of that feature may also occur later on in the presentation or would have already been previously covered in the presentation. In yet another example, a presenter may want to skip through unimportant segments and spend more time on segments that the presenter deems, in the moment, to be more important.

In short, while the use of a pre-recorded video can help during a presentation, the video is necessarily recorded prior to the presentation and cannot necessarily reflect how the presentation flows from one discussion topic (e.g., feature) to another. Consequently, there is a need for presentation software that will permit a user to quickly and easily make ad hoc adjustments to the presentation order of a video during a presentation.

### SUMMARY

A computer-implemented process within a computer hardware system having a video analyzer configured to assist in a presentation of at least a portion of a video to a plurality of participants by a presenter on a presenter client includes the following operations. The video is analyzed to generate a plurality of segments. Presenter data is captured during the presentation, and presenter intent is determined based upon the presenter data. Based upon the presenter intent, forward-looking controls are presented only to the presenter client. One of the plurality of segments is identified using at least one of the presenter intent and the forward-looking controls. The identified one segment is presented to the plurality of participants. In this manner, a user can quickly and easily make ad hoc adjustments to the presentation order of the video during the presentation.

In further aspects of the process, the analyzing the video includes: parsing the video into a plurality of segments and each of the plurality of segments corresponds to a particular feature being demonstrated in the presentation; generating a timeline of the plurality of segments; generating an individual frame for each of the plurality of segments; generating, for each of the plurality of segments, metadata describing the particular feature; and associating, for each of the plurality of segments, a respective frame and metadata. The forward-looking controls can include the individual frames, and the individual frames can be displayed in a visual order based upon the timeline. The forward-looking controls can also/alternatively include an interaction overlay layer including a plurality of interaction zones, and one of the plurality of interaction zones corresponds to an individual segment of the plurality of segments. Alternatively, one of the plurality of interaction zones corresponds to a multiple ones of the plurality of segments, and interaction of the user with the one of the plurality of interaction zones causes frames respectively corresponding to the multiple ones of the plurality of segments to be displayed.

In certain other aspects of the process, the presenter intent is identified by performing natural language processing on speech uttered by the presenter during the presentation, and the identified one segment is identified based upon a comparison of the presenter intent with the metadata. The forward-looking controls being presented are can also be selected based upon the presenter intent. The causing the identified one segment to be presented to the plurality of participants includes inserting a transition segment between the identified one segment and a next segment to be presented.

A computer hardware system includes a video analyzer configured to assist in a presentation of at least a portion of a video to a plurality of participants by a presenter on a presenter client and a hardware processor configured to perform the following executable operations. The video is analyzed to generate a plurality of segments. Presenter data is captured during the presentation, and presenter intent is determined based upon the presenter data. Based upon the presenter intent, forward-looking controls are presented only to the presenter client. One of the plurality of segments is identified using at least one of the presenter intent and the forward-looking controls. The identified one segment is presented to the plurality of participants. In this manner, a user can quickly and easily make ad hoc adjustments to the presentation order of the video during the presentation.

In further aspects of the system, the analyzing the video includes: parsing the video into a plurality of segments and each of the plurality of segments corresponds to a particular feature being demonstrated in the presentation; generating a timeline of the plurality of segments; generating an individual frame for each of the plurality of segments; generating, for each of the plurality of segments, metadata describing the particular feature; and associating, for each of the plurality of segments, a respective frame and metadata. The forward-looking controls can include the individual frames, and the individual frames can be displayed in a visual order based upon the timeline. The forward-looking controls can also/alternatively include an interaction overlay layer including a plurality of interaction zones, and one of the plurality of interaction zones corresponds to an individual segment of the plurality of segments. Alternatively, one of the plurality of interaction zones corresponds to a multiple ones of the plurality of segments, and interaction of the user with the one of the plurality of interaction zones causes frames respectively corresponding to the multiple ones of the plurality of segments to be displayed.

In certain other aspects of the system, the presenter intent is identified by performing natural language processing on speech uttered by the presenter during the presentation, and the identified one segment is identified based upon a comparison of the presenter intent with the metadata. The forward-looking controls being presented are can also be selected based upon the presenter intent. The causing the identified one segment to be presented to the plurality of participants includes inserting a transition segment between the identified one segment and a next segment to be presented.

A computer program product includes computer readable storage medium having stored therein program code for to assisting in a presentation of at least a portion of a video to a plurality of participants by a presenter on a presenter client. The program code, which when executed by a computer hardware system including a video analyzer, causes the computer hardware system to perform the following operations. The video is analyzed to generate a plurality of segments. Presenter data is captured during the presentation, and presenter intent is determined based upon the presenter data. Based upon the presenter intent, forward-looking controls are presented only to the presenter client. One of the plurality of segments is identified using at least one of the presenter intent and the forward-looking controls. The identified one segment is presented to the plurality of participants. In this manner, a user can quickly and easily make ad hoc adjustments to the presentation order of the video during the presentation.

In further aspects of the computer program product, the analyzing the video includes: parsing the video into a plurality of segments and each of the plurality of segments corresponds to a particular feature being demonstrated in the presentation; generating a timeline of the plurality of segments; generating an individual frame for each of the plurality of segments; generating, for each of the plurality of segments, metadata describing the particular feature; and associating, for each of the plurality of segments, a respective frame and metadata. The forward-looking controls can include the individual frames, and the individual frames can be displayed in a visual order based upon the timeline. The forward-looking controls can also/alternatively include an interaction overlay layer including a plurality of interaction zones, and one of the plurality of interaction zones corresponds to an individual segment of the plurality of segments. Alternatively, one of the plurality of interaction zones corresponds to a multiple ones of the plurality of segments, and interaction of the user with the one of the plurality of interaction zones causes frames respectively corresponding to the multiple ones of the plurality of segments to be displayed.

In certain other aspects of the computer program product, the presenter intent is identified by performing natural language processing on speech uttered by the presenter during the presentation, and the identified one segment is identified based upon a comparison of the presenter intent with the metadata. The forward-looking controls being presented are can also be selected based upon the presenter intent. The causing the identified one segment to be presented to the plurality of participants includes inserting a transition segment between the identified one segment and a next segment to be presented.

This Summary section is provided merely to introduce certain concepts and not to identify any key or essential features of the claimed subject matter. Other features of the inventive arrangements will be apparent from the accompanying drawings and from the following detailed description.

### BRIEF DESCRIPTION OF THE DRAWINGS

FIG. 1A is a block diagram illustrating an architecture of an example video presentation system according to an embodiment of the present invention.

FIG. 1B is a block diagram illustrating further aspects of the architecture of FIG. 1A according to an embodiment of the present invention.

FIG. 2 is an example approach of dividing a video into a plurality of segments.

FIG. 3 illustrates screenshots from certain segments of FIG. 2.

FIG. 4A illustrates an example method using the architecture of FIG. 1A according to an embodiment of the present invention.

FIG. 4B illustrates an example method for performing analysis of a video in FIG. 4A according to an embodiment of the present invention.

FIG. 5 illustrates a graphical user interface displayed by the presenter client illustrated in FIG. 1 according to an embodiment of the present invention.

FIG. 6 is a block diagram illustrating an example of computer environment for implementing portions of the methodology of FIGS. 4A-B.

### DETAILED DESCRIPTION

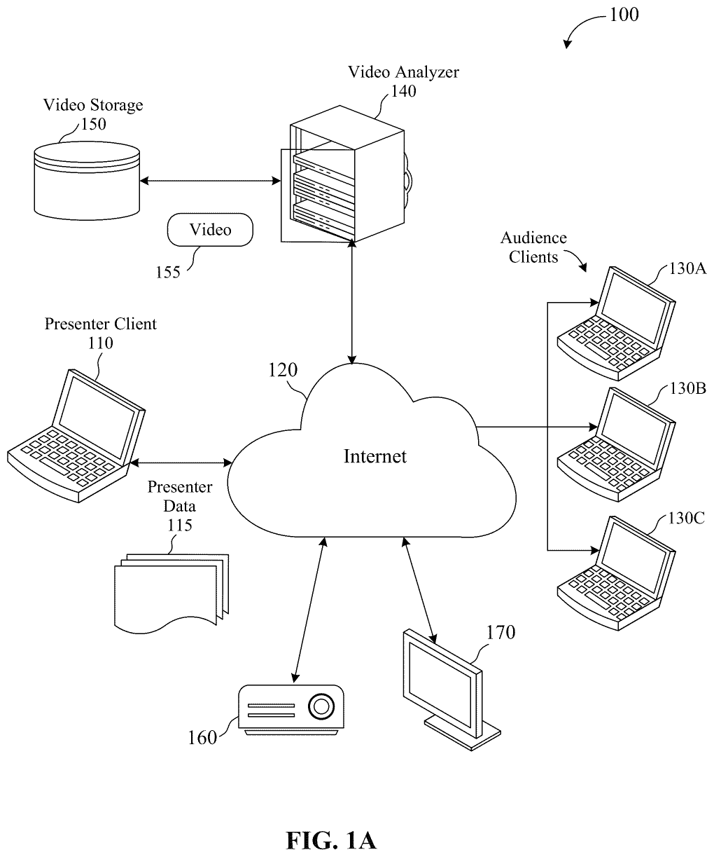

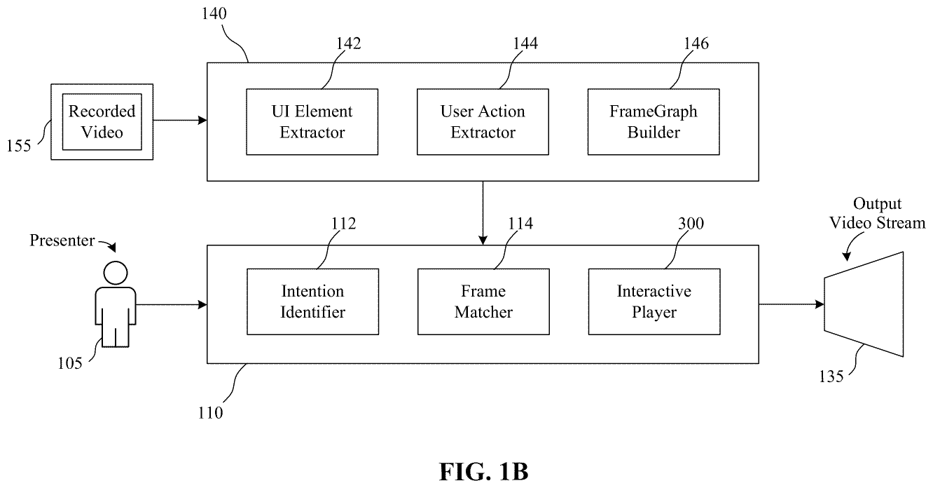

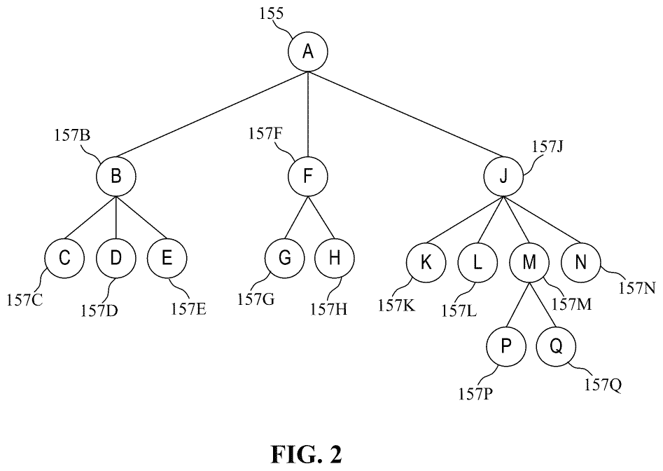

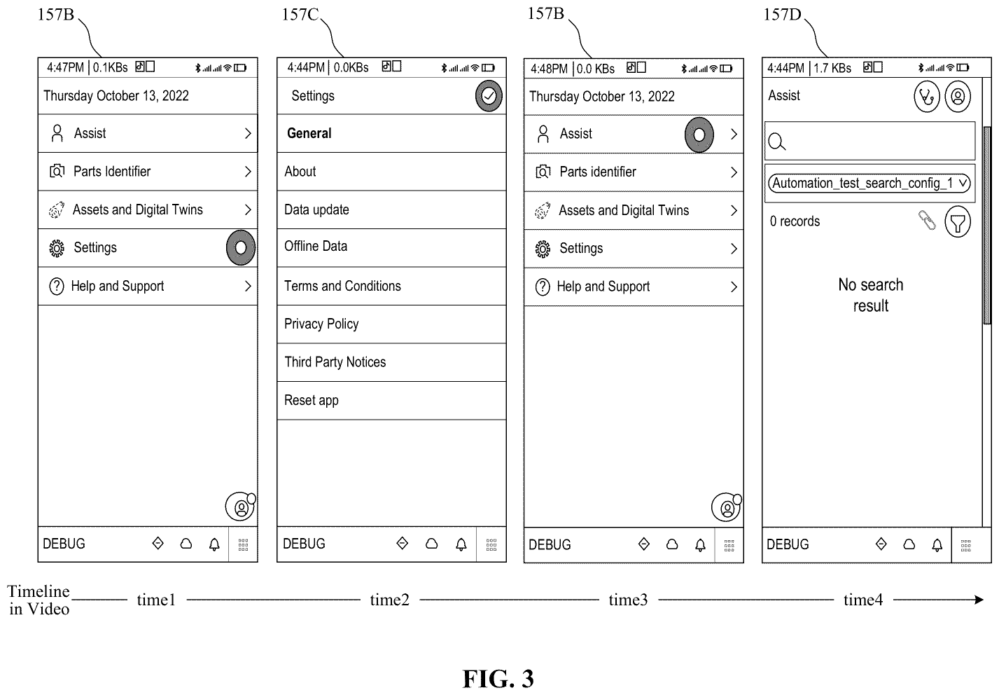

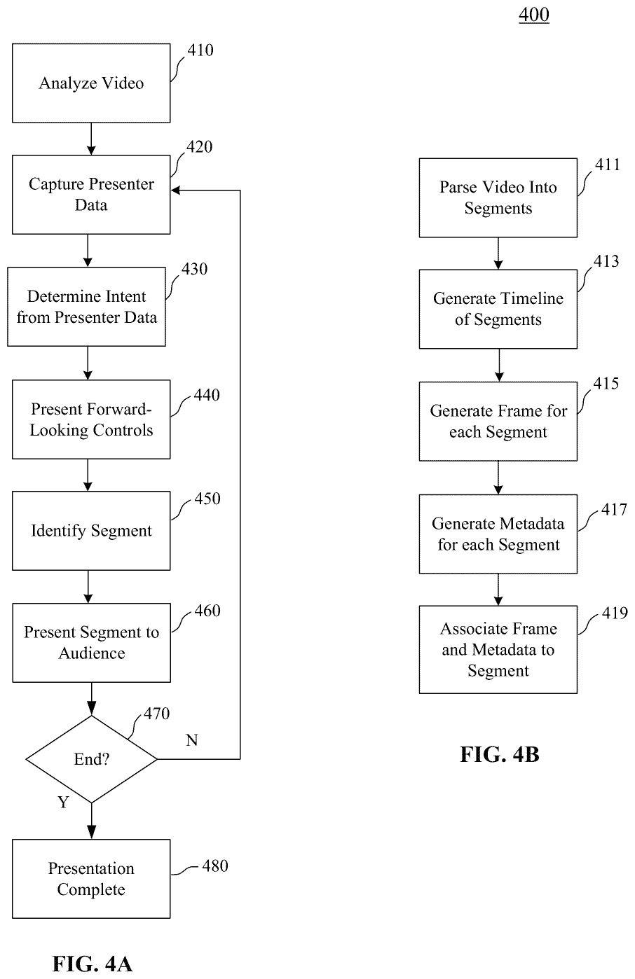

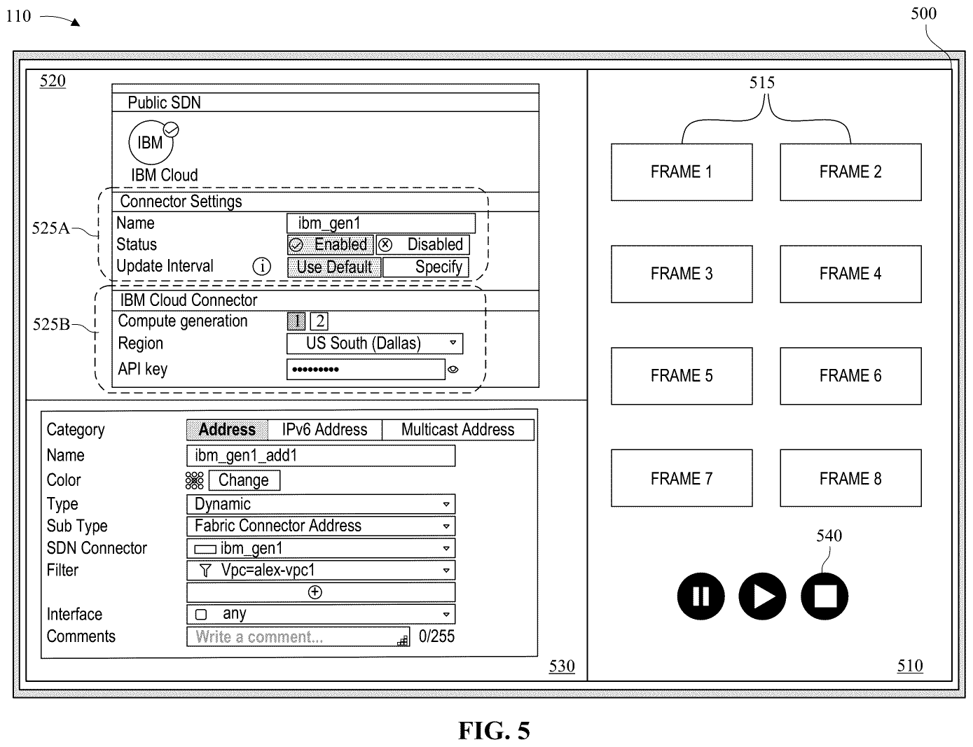

Reference is made to FIGS. 1A-B and FIGS. 4A-4B, which respectively illustrate a video presentation system 100 and methodology 400 for assisting in a presentation of at least a portion of a video 155 to a plurality of participants by a presenter 105 on a presenter client 110. Although the presenter client 110, video analyzer 140, and video storage 150 are illustrated as being separately from one another, one more elements (including all elements) of these devices 110, 140, 150 can be included in one another. Although discussed in more detail below, the video analyzer is configured to perform the following operations. The video 155 is analyzed to generate a plurality of segments 157B-Q. Presenter data 115 is captured during the presentation, and presenter intent is determined based upon the presenter data 115. Based upon the presenter intent, forward-looking controls (e.g., 515 and 525A-B in FIG. 5) can be presented only in the presenter client 110. One of the plurality of segments 157B-Q is identified based upon at least one of the presenter intent and the forward-looking controls, and the identified one segment 157C is presented to the plurality of participants via a video stream 135.

Referring to FIG. 4, in 410, the video analyzer 140 is configured to analyze a pre-recorded video 155 (hereinafter video 155) to generate a plurality of segments 157B-Q and metadata respectively associated with each of the plurality of segments 157B-Q. The video 155 can be received from video storage 150, and as the term implies, the video 155 is pre-recorded prior to the real-time generation of the presentation. As used herein, the term “segment” refers to a discrete portion of the video 155 that includes a frame and/or moving images. A further discussion of a frame is found below.

In certain aspects, each of the plurality of segments 157B-Q represents an individual feature being demonstrated. As used herein, the term “feature” can refer to a particular operation (e.g., activity) and/or a particular component being demonstrated. For example, if the presentation involved demonstrating a graphic user interface (GUI), each individual component of the GUI could be the subject of a particular segment 157B-Q. As another example, if one operation of the GUI is to implement a cloud service, the entirety of that operation or discrete portions of that operation may covered by a particular segment 157B-Q.

The manner by which the segments 157B-Q and metadata are generated from the video 155 are not limited as to a particular technique. However, in certain aspects, the methodology illustrated in FIG. 4B can be employed.

In 411, the video analyzer 140 is configured to parse the video 155 into a plurality of segments 157B-Q. There are multiple different known approaches to parsing a video 155 into a plurality of segments 157B-Q, and the video analyzer 140 is not limited as to a particular approach. Although not limited in this manner, each of the plurality of segments 157B-Q can correspond to a particular feature being demonstrated within the video 155. For example, if the video 155 was demonstrating the operation of a graphical user interface that had ten widgets, each of the segments could correspond to an individual widget.

Additionally, as illustrated in FIG. 4, the video 155 can be broken up into multiple nested segments. For example, if a graphical user interface being demonstrated consisted of three tabbed windows, each of the tabbed windows could have its own segment 157B, 157F, and 157K. Additionally, each of the main segments 157B, 157F, 157K for the tabbed windows could be broken down into additional sub-segments (e.g., 157C-E, 157G-H, 157K-Q) that correspond to individual widgets within each of the tabbed windows. For example, segments 157B, 157F, and 157K could each consist of a frame that corresponds to the tabbed window, and each of the additional sub-segments (e.g., 157C-E, 157G-H, 157K-Q) could be video (i.e., moving pictures) respectively demonstrating the use of different individual features within each of the tabbed windows. Alternatively, instead of being just a frame, each of segments 157B, 157F, and 157K could include a video that leads from the main menu 155 to the respective tabbed window and a frame that corresponds to the tabbed window.

In 413, the video analyzer 140 is configured to generate a timeline of the plurality of segments 157B-Q. There are multiple different known approaches to generating a timeline of a plurality of segments 157B-Q, and the video analyzer 140 is not limited as to a particular approach. As used herein, the “timeline” refers to a computer data structure that identifies a time-wise positional relationship of the segments 157B-Q relative to one another. Although not limited in this manner, the timeline can also indicate a preferred order of presentation of the segments 157B-Q relative to one another. For example, with reference to FIG. 5, the menu illustrated a time1 can correspond to segment 157B (as a menu), in which the “Settings” sub-menu is selected, which can be followed at time2 with sub-segment 157C that demonstrates the “Settings” sub-menu. The timeline continues at time3 with a return to the menu of segment 157B, in which the “Assist” sub-menu is selected. At time4, the “Assist” sub-menu is demonstrated in segment 157D.

In 415, a FrameGraph builder 146 of the video analyzer 140 can be configured to generate a frame 515 (e.g., a thumbnail or image that represents a portion of feature being demonstrated in a segment) for each of the plurality of segments 157B-Q. Although not limited in this manner, in certain aspects, each of the frames 515 visually represent the particular segment 157B-Q to which the frame 515 refers. If a particular segment 157M covers a plurality of different features, in certain aspects, the frame 515 is selected so that it illustrates all of these different features. In this instance, an interaction overlay layer can also be provided for the particular frame 157M, and the interaction overlay layer can include certain interaction zones, which when clicked on (or otherwise activated) indicate that the presenter 105 wants to discuss the feature associated with a particular interaction zone. For example, if the frame is displayed in presenter display window 520 of FIG. 5, each interaction zone 525A, 525B could respectively be associated with one of the sub-segments 157P. 157Q of main segment 157M.

In 417, the video analyzer 140 is configured to generate metadata for each of the plurality of segments 157B-Q. In certain aspects, the metadata is a description of the characteristics of the particular segment 157B-Q to which the metadata applies. For example, if segments 157B, 157F, and 157J respectively corresponded to Tabs A, B, and C of a graphic user interface, a description of these tabs could be included as metadata for the segments 157B, 157F, and 157J. As another example, if a particular operation (e.g., “configure network”) involved one or more segments 157G-H, then a description of this operation could be associated with those segments 157G-H. Although not limited in this manner, the metadata for a particular segment can also include topic, timestamp, features demonstrated in the particular segment, and actions taken during the particular segment.

The video analyzer 140 is not limited as to a particular approach for performing this function. For example, the video analyzer 140 could use a machine learning engine (not shown) in conjunction with the UI element extractor 142 to analyze a particular video segment to identify characteristics of associated with that particular segment. The analysis can be performed on one or both of the moving images (i.e., video) and the static image (i.e., frame). In addition to or alternatively, the video analyzer 140 can be configured to receive user-provided metadata. In 429, the video analyzer 140 is configured to associate each of the plurality of segments 157B-Q with its respective frame 515 and metadata.

An example of metadata associated with a timeline is: timeline: [{time:xxx, frame:{id:xxx, topic:xxx, elements:[{id:xxx, cord: {x1,y1,x2,y2}, label:xxx, focused:xxx, mouseOver:xxx}]}}]. Another example is: timeline: [{time:xxx, frame: {id:xxx, topic:xxx, elements:[{id:xxx, cord: {x1,y1,x2,y2}, label:xxx, focused:xxx, mouseOver:xxx, action:click}]}}]. In generating this metadata, a UI element extractor 142 of the video analyzer 140 can identify user interface elements (if what is being demonstrated is a graphic user interface) of the frames 515. The UI element extractor 142, for example, can compare frames 515 and if a certain percentage of the UI elements are the same, these frames can be marked as being the same frame, which can result in metadata such as: sharedFrames: [{origFrameIds:[id1,id2], elements: [{id:xxx, cord: {x1,y1,x2,y2}, label:xxx, focused:xxx, mouseOver:xxx, action:click}, {id:xxx, cord: {x1,y1,x2,y2}, label:xxx, focused:xxx, mouseOver:xxx, action:click}]}].

Additionally, an user action extractor 144 can be employed to compare frames 515 before and after an action and identify navigation menu components which can result in metadata such as: menuElements: [{id:xxx, label:xxx, ref:[{origFrameId:id, elementId:id}, {origFrameId:id, elementId:id}]}]. In this manner, the user action extractor 144 can analyze each UI component identified by UI element extractor 142 to identify what actions can be taken by a user (e.g., inputting text, clicking on a button, or selecting an item from a menu) and how the user interface reacts to the action (e.g., a popup window is shown or a page is switched).

In 419, presenter data 115 is captured by the presenter client 110 from the presenter 105. As used herein, the term “presenter data” includes presenter speech, presenter gestures, and/or direct interactions with the presenter client 110 by the presenter 105. Consequently, the presenter client 110 can include (or be connected to) a microphone (not shown), for example, to receive presenter speech. The presenter client 110 can also include (or be connected to) a camera (now shown), for example, to capture presenter gestures. The direct interactions with the presenter client 110 by the presenter 105 can include any known interaction with a computer device, such as typing on a keyboard, using a mouse, etcetera. However, in certain aspects of the video presentation system 100, the direct interactions are with a graphical user interface 500 associated with the video analyzer 140.

The FrameGraph builder 146 can be configured to identify, for all of the previously-generated frames, which are shared frames and what frames are associated with particular segments, which is stored as a computer data structure called a Frame Graph. In this manner, relationships between each of the segments 157B-Q can be generated. Consequently, as the presenter 105 interacts with individual frames, the Frame Graph can be consulted to identify what is the next segment to be displayed.

An example of a direct interaction with the graphical user interface 500 can include the presenter 105 interacting with one of the plurality of frames being displayed, for example, in the look-ahead window 510 of the graphic user interface 500 within the presenter client 110. As another example, a direct interaction can be the activation of one of the video controls 540 (e.g., “pause” and “play”) also displayed within the graphical user interface 500. Yet another example of an interaction by the presenter 105 is with the presenter display window 520 of the graphical user interface 500. As discussed above, an interaction overlay layer can be presented over a representation of the feature being demonstrated. The interaction overlay layer can include certain interaction zones (e.g., hot spots) 525A-B, which when clicked on or otherwise activated indicate that the presenter 105 wants to discuss the feature associated with a particular interaction zone. For example, if the presenter 105 interacts with interaction zone 525A, this would indicate that the presenter 105 has identified “Connector Settings” as a topic of interest.

In 430, an intention identifier 112 is configured to determine presenter intent based upon the presenter data 115. A frame matcher 114 can then be used to find frames 515 and corresponding segments 157G-H of the video 155 that correspond to the present intent. For example, if the presenter data 115 includes audio of “let's discuss the network configuration of this application,” the intention identifier 112 can employ a natural language processor (not shown) to determine that an intent of the presenter 105. As another example, if the presenter data 115 includes audio of “let's go back,” the video analyzer 140 can employ the natural language processor to determine an intent of the presenter 105 to return to a prior segment. For example, if segment 157P was playing, a transition segment corresponding to segment 157M could be displayed. In yet another example, if the presenter data 115 includes audio of “let's go back to the main menu for this tab,” a transition segment corresponding to segment 157K could be displayed.

As discussed above, the presenter data 115 can include visual data, and the video analyzer 140 can be configured to determine presenter intent based upon the visual data. For example, the video analyzer 140 can be programmed to recognize hand signals corresponding to video control operations such as “pause” and “play.” Examples of intention types can include: Pause (e.g., presenter 105 needs more time to explain; Resume (e.g., resume playing of current segment); Skip Loading (e.g., jump to another segment that is out of order in the timeline); Redirect (e.g., jump to the demonstration of a particular feature).

In 440, the video presentation system 100 can cause forward-looking controls to be presented only to the presenter client 110 based upon the presenter intent. One example of forward-looking controls is the frames generated for each of the segments 157B-Q. Although not limited in this manner, in certain aspects the display of these frames can be in a visual order based upon the timeline.

Another example of forward-looking controls would be a display of a frame and an associated interaction overlay layer in presenter display window 520 (see FIG. 5). The interaction overlay layer can additionally include one or more selectable interaction zones 525A, 525B (e.g., hotspots). By selecting a particular selectable interaction zone 525A, a segment 157L respectively associated with the selected interaction zone 525A can be selected. In addition to or alternatively, if a particular interaction zone 525B corresponds to a plurality of segments 157P, 157Q, the frames respectively corresponding to the plurality of segments 157P. 157Q can be displayed in the look-ahead window 510 of the graphic user interface 500, and each of these frames can also act as forward-looking controls.

In 450, the video analyzer 140 is configured to identify one of the plurality of segments 157B-Q using at least one of the presenter intent and the forward-looking controls. For example, if the presenter 105 selects one of the frames displayed in the look-ahead window 510, this would indicate that the presenter 105 intends to display the segment corresponding to the particular frame being selected. As another example, if the presenter 105 interacts with an interaction zone 525A, 525B and the interacted with interaction zone 525A, 525B corresponds to the particular segment, this would indicate that the presenter 105 intends to display the segment corresponding to the particular interaction zone 525A, 525B being interacted with. In yet another example, if the presenter intent is based upon an utterance that identifies a particular segment, then that segment could be selected.

In 460, the identified segment 157C of the video 155 is caused to be displayed to the plurality of participants via an output video stream 135. The display of the identified segment 157C of the video 155 can be performed automatically or based upon a manual input. There are many different approaches for displaying portions of a video 155, and the manner by which this accomplished is not limited as to a particular approach. For example, the presenter client 110 may be attached to a projector 160 or a common display screen 170, which are configured to display the identified segment 157C. As another example, the presenter client 110 can cause the identified segment 157C to be displayed on individual audience clients 130A-130C. Through use of the video presentation system 100, the segments of the video 155 presented during the presentation can be presented in an ad hoc order (i.e., different than an order of the plurality of segments 157B-Q contained within the video 155).

If, in 460, after the identified segment 157C has played and a subsequent segment 157D of the video 155 has not been played, the video presentation system 100 can cause a transition segment to be displayed. For example, if the presenter 105 is still discussing identified segment 157C even after the identified segment 157C has been completed, a transition segment can be displayed.

The transition segment may be from the original video 155 or a video segment generated separately from the original video 155 and intended to act as a transition between segments of the video 155. If from the original video 155, the transition segment may be, for example, the frame 515 associated with the identified segment 157C. Alternatively, the transition segment may be a last video frame of the identified segment 157C. As another example, if the video 155 was demonstrating the use of a graphical user interface having multiple menus, the transition segment may display the main menu of the graphical user interface.

A transition segment can also be provided by the video presentation system 100 between different segments being consecutively played during the presentation that were not consecutively-positioned in the original video 155. In this instance, going from one segment 157C to the next segment 157E may present an incoherent jump to the participants. The transition segment is intended to give the participants an indication that a different feature is being discussed using a smooth transition. For example, the transition segment may include a fading out of the prior segment 157C and a fading in of the next segment 157E. Alternatively, the transition segment may include zooming in on a particular element being displayed in the prior segment 157C and a zooming out from a new element being displayed in the next segment 157E. These are just some examples of transition segments and other approaches for a transition segment are capable of being used with the video presentation system 100.

Additionally, depending upon a determination of the presenter's intent, display of the identified segment 157C may be paused during playing of the identified segment 157C. For example, if after the presenter 105 utters “let's pause at this point to discuss this operation further,” a determination can be made by the video presentation system 100 to pause display the segment. Additionally, the presentation of the identified segment 157C can be restarted based upon a determination of the presenter's intent to do so. For example, the presenter 105 may utter something like “let's continue on with discussion of this operation.”

In addition to or alternatively, as illustrated in FIG. 5, the graphical user interface 500 may provide the presenter 105 with video controls 540 that can be interacted with to control the presentation of the identified segment 157C including pausing and restarting of the presentation. For example, “pause” and “resume” buttons can be part of the video controls 540. As another example, the video controls 540 can include (not illustrated) an Enable pauseOnInput control that is configured to cause the current segment to be played to a point before user input and then pause. As yet another example, the video controls 540 can include (not illustrated) an Enable pauseOnTopic control that is configured to cause the current segment to play until the end of a topic and then pause.

In 470, a determination is made whether the presentation has been completed. For example, the presenter data 115 may include a salutation message indicating that the presentation is over (e.g., “Thank you for attending this presentation”). Alternatively, the graphical user interface 500 may present the presenter 105 with a selectable widget (e.g., the stop button as part of the video controls 540) to end the presentation. In 480, upon a determination that the presentation has ended, the process 400 is completed. If the presentation is not completed, the process 400 returns to 420 to gather additional presenter data 115. Consequently, the process can loop through operations 420 through 470 until the presentation has completed.

As defined herein, the term “responsive to” means responding or reacting readily to an action or event. Thus, if a second action is performed “responsive to” a first action, there is a causal relationship between an occurrence of the first action and an occurrence of the second action, and the term “responsive to” indicates such causal relationship.

As defined herein, the term “real time” means a level of processing responsiveness that a user or system senses as sufficiently immediate for a particular process or determination to be made, or that enables the processor to keep up with some external process.

As defined herein, the term “automatically” means without user intervention.

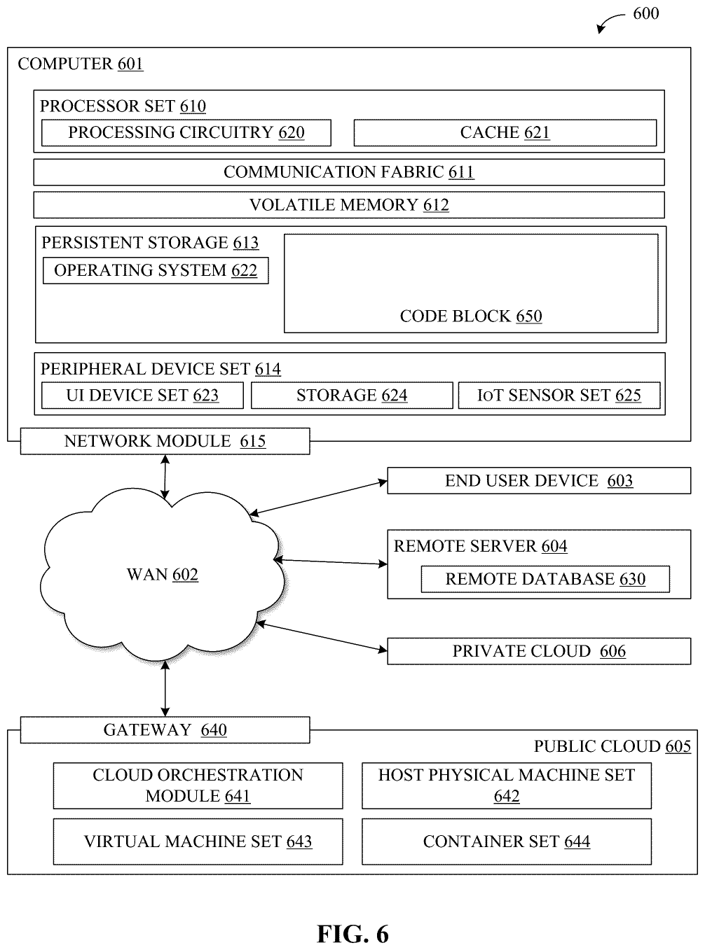

Referring to FIG. 6, computing environment 600 contains an example of an environment for the execution of at least some of the computer code involved in performing the inventive methods, such as feature implementation system code block 650 for implementing the operations of the video presentation system 100. Computing environment 600 includes, for example, computer 601, wide area network (WAN) 602, end user device (EUD) 603, remote server 604, public cloud 605, and private cloud 606. In certain aspects, computer 601 includes processor set 610 (including processing circuitry 620 and cache 621), communication fabric 611, volatile memory 612, persistent storage 613 (including operating system 622 and feature implementation system code block 650), peripheral device set 614 (including user interface (UI), device set 623, storage 624, and Internet of Things (IoT) sensor set 625), and network module 615. Remote server 604 includes remote database 630. Public cloud 605 includes gateway 640, cloud orchestration module 641, host physical machine set 642, virtual machine set 643, and container set 644.

Computer 601 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 630. As is well understood in the art of computer technology, and depending upon the technology, performance of a computer-implemented method may be distributed among multiple computers and/or between multiple locations. However, to simplify this presentation of computing environment 600, detailed discussion is focused on a single computer, specifically computer 601. Computer 601 may or may not be located in a cloud, even though it is not shown in a cloud in FIG. 6 except to any extent as may be affirmatively indicated.

Processor set 610 includes one, or more, computer processors of any type now known or to be developed in the future. As defined herein, the term “processor” means at least one hardware circuit (e.g., an integrated circuit) configured to carry out instructions contained in program code. Examples of a processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller. Processing circuitry 620 may be distributed over multiple packages, for example, multiple, coordinated integrated circuit chips. Processing circuitry 620 may implement multiple processor threads and/or multiple processor cores. Cache 621 is memory that is located in the processor chip package(s) and is typically used for data or code that should be available for rapid access by the threads or cores running on processor set 610. Cache memories are typically organized into multiple levels depending upon relative proximity to the processing circuitry. Alternatively, some, or all, of the cache for the processor set may be located “off chip.” In certain computing environments, processor set 610 may be designed for working with qubits and performing quantum computing.

Computer readable program instructions are typically loaded onto computer 601 to cause a series of operational steps to be performed by processor set 610 of computer 601 and thereby effect a computer-implemented method, such that the instructions thus executed will instantiate the methods specified in flowcharts and/or narrative descriptions of computer-implemented methods discussed above in this document (collectively referred to as “the inventive methods”). These computer readable program instructions are stored in various types of computer readable storage media, such as cache 621 and the other storage media discussed below. The program instructions, and associated data, are accessed by processor set 610 to control and direct performance of the inventive methods. In computing environment 600, at least some of the instructions for performing the inventive methods may be stored in feature implementation system code block 650 in persistent storage 613.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Communication fabric 611 is the signal conduction paths that allow the various components of computer 601 to communicate with each other. Typically, this communication fabric 611 is made of switches and electrically conductive paths, such as the switches and electrically conductive paths that make up busses, bridges, physical input/output ports and the like. Other types of signal communication paths may be used for the communication fabric 611, such as fiber optic communication paths and/or wireless communication paths.

Volatile memory 612 is any type of volatile memory now known or to be developed in the future. Examples include dynamic type random access memory (RAM) or static type RAM. Typically, the volatile memory 612 is characterized by random access, but this is not required unless affirmatively indicated. In computer 601, the volatile memory 612 is located in a single package and is internal to computer 601. In addition to alternatively, the volatile memory 612 may be distributed over multiple packages and/or located externally with respect to computer 601.

Persistent storage 613 is any form of non-volatile storage for computers that is now known or to be developed in the future. The non-volatility of the persistent storage 613 means that the stored data is maintained regardless of whether power is being supplied to computer 601 and/or directly to persistent storage 613. Persistent storage 613 may be a read only memory (ROM), but typically at least a portion of the persistent storage 613 allows writing of data, deletion of data and re-writing of data. Some familiar forms of persistent storage 613 include magnetic disks and solid state storage devices. Operating system 622 may take several forms, such as various known proprietary operating systems or open source Portable Operating System Interface type operating systems that employ a kernel. The code included in feature implementation system code block 650 typically includes at least some of the computer code involved in performing the inventive methods.

Peripheral device set 614 includes the set of peripheral devices for computer 601. Data communication connections between the peripheral devices and the other components of computer 601 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet.

In various aspects, UI device set 623 may include components such as a display screen, speaker, microphone, wearable devices (such as goggles and smart watches), keyboard, mouse, printer, touchpad, game controllers, and haptic devices. Storage 624 is external storage, such as an external hard drive, or insertable storage, such as an SD card. Storage 624 may be persistent and/or volatile. In some aspects, storage 624 may take the form of a quantum computing storage device for storing data in the form of qubits. In aspects where computer 601 is required to have a large amount of storage (for example, where computer 601 locally stores and manages a large database) then this storage 624 may be provided by peripheral storage devices designed for storing very large amounts of data, such as a storage area network (SAN) that is shared by multiple, geographically distributed computers. Internet-of-Things (IoT) sensor set 625 is made up of sensors that can be used in IoT applications. For example, one sensor may be a thermometer and another sensor may be a motion detector.

Network module 615 is the collection of computer software, hardware, and firmware that allows computer 601 to communicate with other computers through a Wide Area Network (WAN) 602. Network module 615 may include hardware, such as modems or Wi-Fi signal transceivers, software for packetizing and/or de-packetizing data for communication network transmission, and/or web browser software for communicating data over the internet. In certain aspects, network control functions and network forwarding functions of network module 615 are performed on the same physical hardware device. In other aspects (for example, aspects that utilize software-defined networking (SDN)), the control functions and the forwarding functions of network module 615 are performed on physically separate devices, such that the control functions manage several different network hardware devices. Computer readable program instructions for performing the inventive methods can typically be downloaded to computer 601 from an external computer or external storage device through a network adapter card or network interface included in network module 615.

WAN 602 is any Wide Area Network (for example, the internet) capable of communicating computer data over non-local distances by any technology for communicating computer data, now known or to be developed in the future. In some aspects, the WAN 602 may be replaced and/or supplemented by local area networks (LANs) designed to communicate data between devices located in a local area, such as a Wi-Fi network. The WAN 602 and/or LANs typically include computer hardware such as copper transmission cables, optical transmission fibers, wireless transmission, routers, firewalls, switches, gateway computers and edge servers.

End user device (EUD) 603 is any computer system that is used and controlled by an end user (for example, a customer of an enterprise that operates computer 601), and may take any of the forms discussed above in connection with computer 601. EUD 603 typically receives helpful and useful data from the operations of computer 601. For example, in a hypothetical case where computer 601 is designed to provide a recommendation to an end user, this recommendation would typically be communicated from network module 615 of computer 601 through WAN 602 to EUD 603. In this way, EUD 603 can display, or otherwise present, the recommendation to an end user. In certain aspects, EUD 603 may be a client device, such as thin client, heavy client, mainframe computer, desktop computer and so on.

As defined herein, the term “client device” means a data processing system that requests shared services from a server, and with which a user directly interacts. Examples of a client device include, but are not limited to, a workstation, a desktop computer, a computer terminal, a mobile computer, a laptop computer, a netbook computer, a tablet computer, a smart phone, a personal digital assistant, a smart watch, smart glasses, a gaming device, a set-top box, a smart television and the like. Network infrastructure, such as routers, firewalls, switches, access points and the like, are not client devices as the term “client device” is defined herein. As defined herein, the term “user” means a person (i.e., a human being).

Remote server 604 is any computer system that serves at least some data and/or functionality to computer 601. Remote server 604 may be controlled and used by the same entity that operates computer 601. Remote server 604 represents the machine(s) that collect and store helpful and useful data for use by other computers, such as computer 601. For example, in a hypothetical case where computer 601 is designed and programmed to provide a recommendation based on historical data, then this historical data may be provided to computer 601 from remote database 630 of remote server 604. As defined herein, the term “server” means a data processing system configured to share services with one or more other data processing systems.

Public cloud 605 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 605 is performed by the computer hardware and/or software of cloud orchestration module 641. The computing resources provided by public cloud 605 are typically implemented by virtual computing environments that run on various computers making up the computers of host physical machine set 642, which is the universe of physical computers in and/or available to public cloud 605. The virtual computing environments (VCEs) typically take the form of virtual machines from virtual machine set 643 and/or containers from container set 644. It is understood that these VCEs may be stored as images and may be transferred among and between the various physical machine hosts, either as images or after instantiation of the VCE. Cloud orchestration module 641 manages the transfer and storage of images, deploys new instantiations of VCEs and manages active instantiations of VCE deployments. Gateway 640 is the collection of computer software, hardware, and firmware that allows public cloud 605 to communicate through WAN 602.

VCEs can be stored as “images,” and a new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 606 is similar to public cloud 605, except that the computing resources are only available for use by a single enterprise. While private cloud 606 is depicted as being in communication with WAN 602, in other aspects, a private cloud 606 may be disconnected from the internet entirely (e.g., WAN 602) and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this aspect, public cloud 605 and private cloud 606 are both part of a larger hybrid cloud.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

As another example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions. Each block in the flowchart or block diagrams may represent a module, segment, or portion of instructions, which comprises one or more executable instructions for implementing the specified logical function(s).

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “includes,” “including,” “comprises,” and/or “comprising,” when used in this disclosure, specify the presence of stated features, integers, steps, operations, elements, and/or components, but do not preclude the presence or addition of one or more other features, integers, steps, operations, elements, components, and/or groups thereof.

Reference throughout this disclosure to “one embodiment,” “an embodiment,” “one arrangement,” “an arrangement,” “one aspect.” “an aspect,” or similar language means that a particular feature, structure, or characteristic described in connection with the embodiment is included in at least one embodiment described within this disclosure. Thus, appearances of the phrases “one embodiment,” “an embodiment,” “one arrangement,” “an arrangement,” “one aspect,” “an aspect,” and similar language throughout this disclosure may, but do not necessarily, all refer to the same embodiment.

The term “plurality,” as used herein, is defined as two or more than two. The term “another,” as used herein, is defined as at least a second or more. The term “coupled,” as used herein, is defined as connected, whether directly without any intervening elements or indirectly with one or more intervening elements, unless otherwise indicated. Two elements also can be coupled mechanically, electrically, or communicatively linked through a communication channel, pathway, network, or system. The term “and/or” as used herein refers to and encompasses any and all possible combinations of one or more of the associated listed items. It will also be understood that, although the terms first, second, etc. may be used herein to describe various elements, these elements should not be limited by these terms, as these terms are only used to distinguish one element from another unless stated otherwise or the context indicates otherwise.

The term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context. As used herein, the terms “if,” “when,” “upon,” “in response to,” and the like are not to be construed as indicating a particular operation is optional. Rather, use of these terms indicate that a particular operation is conditional. For example and by way of a hypothetical, the language of “performing operation A upon B” does not indicate that operation A is optional. Rather, this language indicates that operation A is conditioned upon B occurring.

The foregoing description is just an example of embodiments of the invention, and variations and substitutions. While the disclosure concludes with claims defining novel features, it is believed that the various features described herein will be better understood from a consideration of the description in conjunction with the drawings. The process(es), machine(s), manufacture(s) and any variations thereof described within this disclosure are provided for purposes of illustration. Any specific structural and functional details described are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

What is claimed is:

1. A computer-implemented method within a computer hardware system having a video analyzer for assisting in a presentation of at least a portion of a video to a plurality of participants by a presenter on a presenter client, comprising:
analyzing the video to generate a plurality of segments;
capturing presenter data during the presentation;
determining presenter intent based upon the presenter data;
causing, based upon the presenter intent, forward-looking controls to be presented only to the presenter client;
identifying one of the plurality of segments using at least one of the presenter intent and the forward-looking controls; and
causing the identified one segment to be presented to the plurality of participants.

2. The method of claim 1, wherein
the analyzing the video includes:
parsing the video into a plurality of segments and each of the plurality of segments corresponds to a particular feature being demonstrated in the presentation;
generating a timeline of the plurality of segments;
generating an individual frame for each of the plurality of segments;
generating, for each of the plurality of segments, metadata describing the particular feature; and
associating, for each of the plurality of segments, a respective frame and metadata.

3. The method of claim 2, wherein
the forward-looking controls includes the individual frames, and
the individual frames are displayed in a visual order based upon the timeline.

4. The method of claim 2, wherein
the forward-looking controls includes an interaction overlay layer including a plurality of interaction zones, and
one of the plurality of interaction zones corresponds to an individual segment of the plurality of segments.

5. The method of claim 2, wherein
the forward-looking controls includes an interaction overlay layer including a plurality of interaction zones,
one of the plurality of interaction zones corresponds to a multiple ones of the plurality of segments, and
interaction of the user with the one of the plurality of interaction zones causes frames respectively corresponding to the multiple ones of the plurality of segments to be displayed.

6. The method of claim 1, wherein
the presenter intent is identified by performing natural language processing on speech uttered by the presenter during the presentation, and
the identified one segment is identified based upon a comparison of the presenter intent with the metadata.

7. The method of claim 1, wherein
the presenter intent is identified by performing natural language processing on speech uttered by the presenter during the presentation, and
the forward-looking controls being presented are selected based upon the presenter intent.

8. The method of claim 1, wherein
the causing the identified one segment to be presented to the plurality of participants includes inserting a transition segment between the identified one segment and a next segment to be presented.

9. A computer hardware system configured to assist in a presentation of at least a portion of a video to a plurality of participants by a presenter on a presenter client, comprising:
a hardware processor including a video analyzer and configured to perform the following executable operations:
analyzing the video to generate a plurality of segments;
capturing presenter data during the presentation;
determining presenter intent based upon the presenter data;
causing, based upon the presenter intent, forward-looking controls to be presented only to the presenter client;
identifying one of the plurality of segments using at least one of the presenter intent and the forward-looking controls; and
causing the identified one segment to be presented to the plurality of participants.

10. The system of claim 9, wherein
the analyzing the video includes:
parsing the video into a plurality of segments and each of the plurality of segments corresponds to a particular feature being demonstrated in the presentation;
generating a timeline of the plurality of segments;
generating an individual frame for each of the plurality of segments;
generating, for each of the plurality of segments, metadata describing the particular feature; and
associating, for each of the plurality of segments, a respective frame and metadata.

11. The system of claim 10, wherein
the forward-looking controls includes the individual frames, and
the individual frames are displayed in a visual order based upon the timeline.

12. The system of claim 10, wherein
the forward-looking controls includes an interaction overlay layer including a plurality of interaction zones, and
one of the plurality of interaction zones corresponds to an individual segment of the plurality of segments.

13. The system of claim 10, wherein
the forward-looking controls includes an interaction overlay layer including a plurality of interaction zones,
one of the plurality of interaction zones corresponds to a multiple ones of the plurality of segments, and
interaction of the user with the one of the plurality of interaction zones causes frames respectively corresponding to the multiple ones of the plurality of segments to be displayed.

14. The system of claim 9, wherein
the presenter intent is identified by performing natural language processing on speech uttered by the presenter during the presentation, and
the identified one segment is identified based upon a comparison of the presenter intent with the metadata.

15. The system of claim 9, wherein
the presenter intent is identified by performing natural language processing on speech uttered by the presenter during the presentation, and
the forward-looking controls being presented are selected based upon the presenter intent.

16. The system of claim 9, wherein
the causing the identified one segment to be presented to the plurality of participants includes inserting a transition segment between the identified one segment and a next segment to be presented.

17. A computer program product, comprising:
a computer readable storage medium having stored therein program code for assisting in a presentation of at least a portion of a video to a plurality of participants by a presenter on a presenter client,
the program code, which when executed by the computer hardware system including a video analyzer, causes the computer hardware system to perform:
analyzing the video to generate a plurality of segments;
capturing presenter data during the presentation;
determining presenter intent based upon the presenter data;
causing, based upon the presenter intent, forward-looking controls to be presented only to the presenter client;
identifying one of the plurality of segments using at least one of the presenter intent and the forward-looking controls; and
causing the identified one segment to be presented to the plurality of participants.

18. The computer program product of claim 17, wherein
the analyzing the video includes:
parsing the video into a plurality of segments and each of the plurality of segments corresponds to a particular feature being demonstrated in the presentation;
generating a timeline of the plurality of segments;
generating an individual frame for each of the plurality of segments;
generating, for each of the plurality of segments, metadata describing the particular feature; and
associating, for each of the plurality of segments, a respective frame and metadata.

19. The computer program product of claim 18, wherein
the forward-looking controls includes an interaction overlay layer including a plurality of interaction zones, and
one of the plurality of interaction zones corresponds to an individual segment of the plurality of segments.

20. The computer program product of claim 17, wherein
the presenter intent is identified by performing natural language processing on speech uttered by the presenter during the presentation, and
the identified one segment is identified based upon a comparison of the presenter intent with the metadata.
